(19) United States
(12) Patent Application Publication
(10) Pub. No.: US 2020/0314925 A1
(43) Pub. Date: Oct. 1, 2020

(54) NETWORK SYSTEM, COMMUNICATION TERMINAL, AND RECORDING MEDIUM

(71) Applicant: SHARP KABUSHIKI KAISHA, Sakai City (JP)

(72) Inventors: AOGU FUJII, Sakai City (JP); TAKUYA NOZU, Sakai City (JP); TSUYOSHI IWAMOTO, Sakai City (JP)

(21) Appl. No.: 16/827,663

(22) Filed: Mar. 23, 2020

(30) Foreign Application Priority Data
Mar. 28, 2019 (JP) 2019-063361

(51) Int. Cl. H04W 76/11; H04W 4/80; H04W 8/00; H04W 84/18; H04W 84/12

(52) U.S. Cl. CPC H04W 76/11; H04W 4/80; H04W 84/12; H04W 84/18; H04W 8/005

(57) ABSTRACT

A network system includes an electric apparatus and a communication terminal. The electric apparatus emits a non-connectable beacon by a first communication scheme compliant to Bluetooth (registered trademark). The communication terminal outputs a notification for connection based on the non-connectable beacon. The electric apparatus emits a connectable beacon by the first communication scheme in a case where the electric apparatus directly accepts an operation of a user. In a case where the communication terminal receives the connectable beacon after the user responds to the notification, the communication terminal and the electric apparatus connect to each other by the first communication scheme.

### BACKGROUND

### 1. Field

The present disclosure relates to technology for wireless communication among electric apparatuses.

### 2. Description of the Related Art

There is known a technology in the related art where an electric apparatus is remotely controlled by a communication terminal, or information of the electric apparatus is acquired by the communication terminal, by associating the electric apparatus and the communication terminal with each other. For example, Japanese Unexamined Patent Application Publication No. 2018-32917 discloses a network system, an information processing method, a server, an electric apparatus, a communication terminal, and a program. According to Japanese Unexamined Patent Application Publication No. 2018-32917, there is provided a network system including at least one electric apparatus connected via a local area network (LAN), a communication terminal for displaying the at least one electric apparatus connected via the LAN in a selectable manner, and a server for executing predetermined processing related to an electric apparatus, which is selected on the basis of a command given to the communication terminal to select at least one electric apparatus, and the communication terminal.

It is desirable to provide a network system where exchange of data between an electric apparatus and a communication terminal can be started more easily than that in the related art.

### SUMMARY

According to an aspect of the disclosure, there is provided a network system including an electric apparatus and a communication terminal. The electric apparatus emits a non-connectable beacon, such as one-way data not for pairing, for example, by a first communication scheme compliant to Bluetooth (registered trademark). The communication terminal outputs a notification for connection based on the non-connectable beacon. The electric apparatus emits a connectable beacon by the first communication scheme in a case where the electric apparatus directly accepts an operation of a user. In a case where the communication terminal receives the connectable beacon after the user responds to the notification, the communication terminal and the electric apparatus connect to each other by the first communication scheme.

### BRIEF DESCRIPTION OF THE DRAWINGS

FIG. 1 is a conceptual diagram illustrating an overall configuration of a network system according to a first embodiment;

FIG. 2 is a conceptual diagram illustrating an operational overview of the network system according to the first embodiment;

FIG. 3 is a block diagram illustrating a configuration of an electric apparatus according to the first embodiment;

FIG. 4 is a block diagram illustrating a configuration of a communication terminal according to the first embodiment;

FIG. 5 is a block diagram illustrating a configuration of a server according to the first embodiment;

FIG. 6A is a first sequence diagram illustrating information processing of the network system according to the first embodiment; and

FIG. 6B is a second sequence diagram illustrating information processing of the network system according to the first embodiment.

### DESCRIPTION OF THE EMBODIMENTS

Embodiments of the present disclosure will be described with reference to the drawings. Parts that are the same are denoted by the same symbols in the following description. The names and functions thereof also are the same. Accordingly, detailed description thereof will not be repeated.

### First Embodiment

### Overall Configuration of Network System

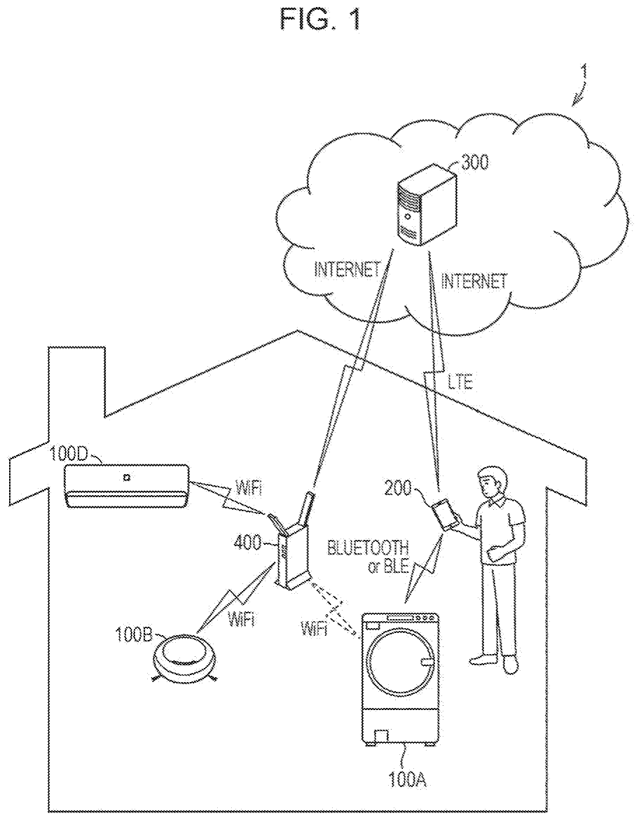

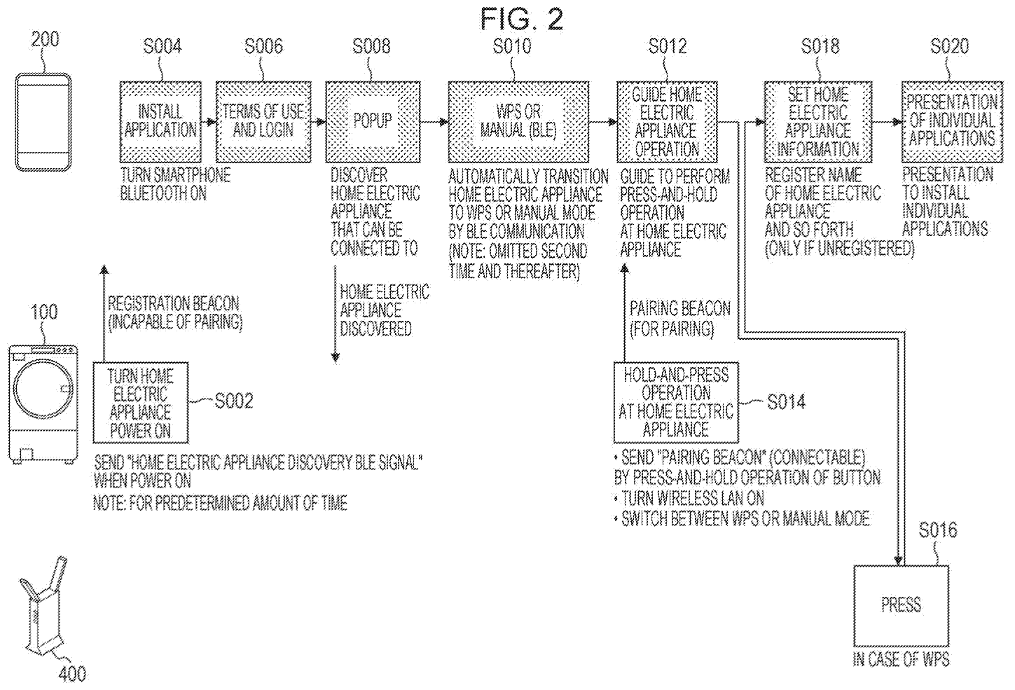

A simple overall configuration of the network system 1 according to the present embodiment will be described first with reference to FIGS. 1 and 2. The network system 1 basically includes various electric apparatuses such as a washing machine 100A, a vacuum cleaner 100B, an air conditioner 100D, and so forth, which are installed in homes and offices, the communication terminal 200 such as a smartphone or the like that a user who uses the electric apparatus has, the server 300 for home electric appliance control that controls the electric apparatuses 100 in accordance with instructions from the communication terminal 200, and so forth.

Note that electric apparatuses are not restricted to the washing machine 100A, vacuum cleaner 100B, and air conditioner 100D illustrated in FIG. 1, and may be home electric appliances such as a refrigerator, microwave oven, rice cooker, and so forth, audio and visual (AV) apparatuses such as a television set, hard disk recorder, music player, projector, speaker, robot, and so forth, household equipment such as a solar power generator, intercom, water heater, and so forth, or the like. These devices are also collectively referred to as “electric apparatuses 100”. The electric apparatuses 100 in the present embodiment are connected to the Internet basically via a router 400.

Also, the communication terminal is not restricted to a smartphone such as illustrated in FIG. 1, and may be a tablet, personal computer, speaker, wearable terminal, robot, gaming device, electronic book terminal, or the like. These devices are collectively referred to as “communication terminal 200”. The communication terminal 200 may be connected to the Internet via the router 400, or may be connected to the Internet via a carrier network such as a network compliant to the LTE (Long-Term Evolution) standard. Operational Overview of Network System

Next, an operational overview of the network system 1 according to the present embodiment will be described with reference to FIGS. 1 and 2.

First, when a user purchases a new electric apparatus 100 and turns the power on, the electric apparatus 100 begins periodically broadcasting a non-connectable beacon using a Bluetooth Low Energy (BLE)-compliant communication scheme, for example (step S002). Note that besides turning the power on serving as a trigger, a beacon may be emitted for a short time upon detecting opening/closing of a door, proximity of a person, or the like. This beacon may include the type and identification number of the electric apparatus 100, but is one-way data not for pairing. Emission of this beacon may be continued until a “press-and-hold” operation in later-described step S014 is performed, or Wi-Fi (registered trademark) connection with the router 400 is successful, or until the power of the electric apparatus 100 is turned off.

The user downloads and installs an application program for home electric appliance control to the communication terminal 200 (step S004). The user checks terms of use of a home electric appliance control service, and logs in to the service (step S006). Note that installation of the application and login to the service may be already completed before purchasing or installation of the electric apparatus 100.

Upon receiving the beacon from the electric apparatus 100, the communication terminal 200 gives a popup notification that access has been made from the electric apparatus 100 (step S008). For example, the user may be notified of a message that the electric apparatus 100 has been discovered, or the type or the like of the electric apparatus 100, by audio or display.

When the user grants permission to continue connection processing, the communication terminal 200 accepts a command from the user to select whether to connect the electric apparatus 100 to the router 400 in a Wi-Fi Protected Setup (WPS) mode, or to connect to the router 400 by a manual input (step S010).

The communication terminal 200 then downloads from the server 300 an instruction manual for Wi-Fi (registered trademark) connection with the router 400, in accordance with the type of the electric apparatus 100 (step S012). The communication terminal 200 displays or provides audio guidance of how to perform Wi-Fi (registered trademark) connection of the electric apparatus 100.

Upon the user following the instruction manual and performing a “press-and-hold” operation on a predetermined button of the electric apparatus 100, the electric apparatus 100 emits a connectable beacon for pairing to the communication terminal 200, using a BLE-compliant communication scheme (step S014). This beacon includes the type and identification number of the electric apparatus 100, and is data for pairing with each other.

In the present embodiment, when the communication terminal 200 receives this connectable beacon from the electric apparatus 100 following an affirmative operation by the user in response to the notification in step S008, pairing is performed with the electric apparatus 100 by a BLE-compliant communication scheme. Note that this is not restricted to pairing involving encryption, rather, it is sufficient for a connection state to be established where data can be exchanged bidirectionally. Thus, the communication terminal 200 transmits to the electric apparatus 100 a selection command for whether the WPS mode or a manual input mode is to be used with regard to Wi-Fi (registered trademark) connection of the electric apparatus 100.

The electric apparatus 100 turns a wireless LAN function on, and transitions to the WPS mode or the manual input mode.

Upon the user pressing a WPS button of the wireless router 400 for Wi-Fi (registered trademark) (step S016), the wireless router 400 and the electric apparatus 100 exchange relevant information and perform Wi-Fi (registered trademark) connection.

Thereafter, the user can use the communication terminal 200 to perform pairing with regard to the home electric appliance control service between the electric apparatus 100 and communication terminal 200, register various types of information about the electric apparatus 100 (step S018), and browse detailed presentations of other application programs (step S020).

Note that the BLE pairing is not restricted to BLE pairing by the electric apparatus 100 emitting a non-connectable beacon and subsequently emitting a connectable beacon. A function may be provided where BLE pairing processing is performed by a press-and-hold operation being performed on a predetermined button of the electric apparatus 100 in a state where the non-connectable beacon is stopped, to emit the connectable beacon.

Thus, the user does not have to perform complicated processing on the electric apparatus 100 or communication terminal 200 with regard to Wi-Fi (registered trademark) connection in the network system 1 according to the present embodiment. The configuration of the network system 1 for realizing these functions will be described in detail below.

### Configuration of Electric Apparatus 100

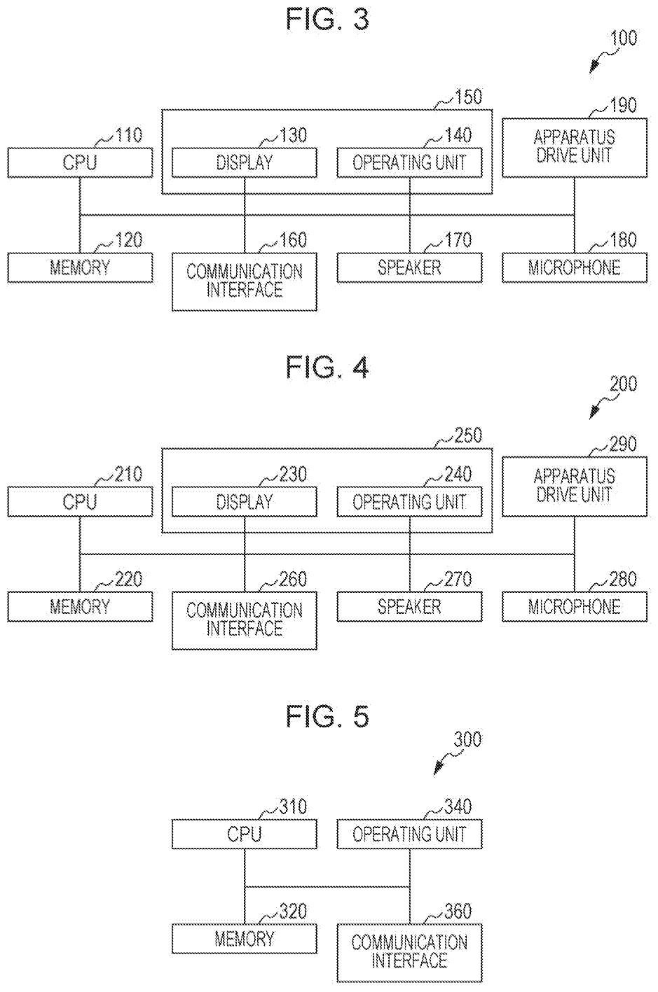

The configuration of the electric apparatus 100 making up the network system 1 according to the present embodiment will be described. With reference to FIG. 3, the electric apparatus 100 according to the present embodiment includes, as basic components, a CPU 110, memory 120, a display 130, an operating unit 140, a communication interface 160, a speaker 170, a microphone 180, and an apparatus drive unit 190.

The CPU 110 controls each part of the electric apparatus 100 by executing programs stored in the memory 120 or an external storage medium.

The memory 120 is realized by various types of random access memory (RAM), various types of read-only memory (ROM), or the like. The memory 120 may be embedded in the electric apparatus 100, may be detachably mountable to various types of interfaces of the electric apparatus 100, or may be a recording medium of another device that the electric apparatus 100 is capable of accessing. The memory 120 stores relevant information and the like for using various types of services, such as programs to be executed by the CPU 110, data generated by the CPU 110 executing a program, data input via the operating unit 140, data received from a remote controller, data received from the server 300 via the router 400 or the Internet, addresses of servers corresponding to the electric apparatus 100, and so forth.

The display 130 outputs text, images, and so forth, on the basis of signals from the CPU 110. Note that the display 130 may simply be a light-emitting diode (LED) light or the like.

The operating unit 140 is realized by buttons, a touchscreen, or the like, and accepts commands from the user and inputs these commands to the CPU 110. The operating unit 140 includes a relevant button used for Wi-Fi (registered trademark) connection and so forth, for example. Note that the display 130 and operating unit 140 may make up a touchscreen 150.

The communication interface 160 is realized by an antenna for performing BLE-compliant wireless communication or Wi-Fi (registered trademark)-compliant wireless communication, a connector for performing wired communication, or the like. Note that the communication interface 160 may be provided to an adapter board for communication, separately from a basic control board of the electric apparatus 100.

The CPU 110 then directly exchanges data with the communication terminal 200 via the communication interface 160, by a BLE-compliant communication scheme. The CPU 110 also exchanges data with the router 400, communication terminal 200, and electric apparatus 100 by a Wi-Fi (registered trademark)-compliant communication scheme via the communication interface 160. The CPU 110 also communicates with the server 300 and the cloud via the communication interface 160 and router 400.

The speaker 170 outputs audio messages and so forth on the basis of audio data from the CPU 110. The microphone 180 acquires voice of the user and so forth and inputs audio data to the CPU 110.

The apparatus drive unit 190 controls each part of the electric apparatus 100 (motor, heater, sensor, antenna, etc.), on the basis of signals from the CPU 110. For example, this might be a motor in the case of the washing machine 100A, a compressor or fan in the case of the air conditioner 100D, an antenna or turntable for cooking by heating in the case of a microwave oven, and so forth. Configuration of Communication Terminal 200

Next, the configuration of the communication terminal 200 making up the network system 1 according to the present embodiment will be described. With reference to FIG. 4, the communication terminal 200 according to the present embodiment includes, as basic components, a CPU 210, memory 220, a display 230, an operating unit 240, a communication interface 260, a speaker 270, a microphone 280, and an apparatus drive unit 290.

The CPU 210 controls each part of the communication terminal 200 by executing programs stored in the memory 220.

The memory 220 is realized by various types of RAM, various types of ROM, or the like. The memory 220 stores application programs for using various types of services, data generated by the CPU 210 executing a program, data received from the server 300 or the electric apparatuses 100, data input via the operating unit 240, information for identifying the user of the communication terminal 200, and so forth.

The display 230 displays images and text on the basis of data from the CPU 210. The operating unit 240 is made up of a pointing device, switches, and so forth, and inputs various types of commands from the user to the CPU 210. Note that the user terminal may have a touchscreen 250 including the display 230 and operating unit 240.

The communication interface 260 is realized by an antenna for performing BLE-compliant wireless communication or Wi-Fi (registered trademark)-compliant wireless communication, a connector for performing wired communication such as Universal Serial Bus (USB), or the like. The CPU 210 directly exchanges data with the electric apparatuses 100 by a BLE-compliant communication scheme via the communication interface 260. The CPU 210 exchanges data with the router 400 and electric apparatuses 100 by a Wi-Fi (registered trademark)-compliant communication scheme via the communication interface 260. The CPU 210 also communicates with the server 300 on the Internet or in the cloud via the communication interface 260 and router 400.

The speaker 270 outputs audio on the basis of signals from the CPU 210. The microphone 280 acquires audio and inputs audio signals to the CPU 210.

### Configuration of Server 300

Next, one form of the configuration of the server 300 for home electric appliance control making up the network system 1 according to the present embodiment will be described. With reference to FIG. 5, the server 300 includes, as basic components, a CPU 310, memory 320, an operating unit 340, and a communication interface 360.

The CPU 310 controls each part of the server 300 by executing programs stored in the memory 320.

The memory 320 is realized by various types of RAM, various types of ROM, or the like. The memory 320 may be embedded in the server 300, may be detachably mountable to various types of interfaces of the server 300, or may be a recording medium of another device that the server 300 is capable of accessing. The memory 320 stores programs to be executed by the CPU 310, data generated by the CPU 310 executing a program, input data, data indicating a pairing relation between the electric apparatus 100 and communication terminal 200, databases used for other processing and services according to the present embodiment, and so forth.

The operating unit 340 receives commands from a service administrator or the like, and inputs these commands to the CPU 310.

The communication interface 360 transmits data from the CPU 310 to other devices, such as the electric apparatus 100, communication terminal 200, other servers, and so forth, via the Internet, a carrier network, the router 400, and so forth. Conversely, the communication interface 360 receives data from other devices, such as the electric apparatus 100, communication terminal 200, other servers, and so forth, and hands this data to the CPU 310 via the Internet, carrier network, router 400, and so forth.

Thus, with regard to the server 300 for home electric appliance control, the CPU 310 transmits control commands to the relevant electric apparatus 100 on the basis of control commands or tokens from the communication terminal 200 of the user, via the communication interface 360.

Information processing of Network System 1

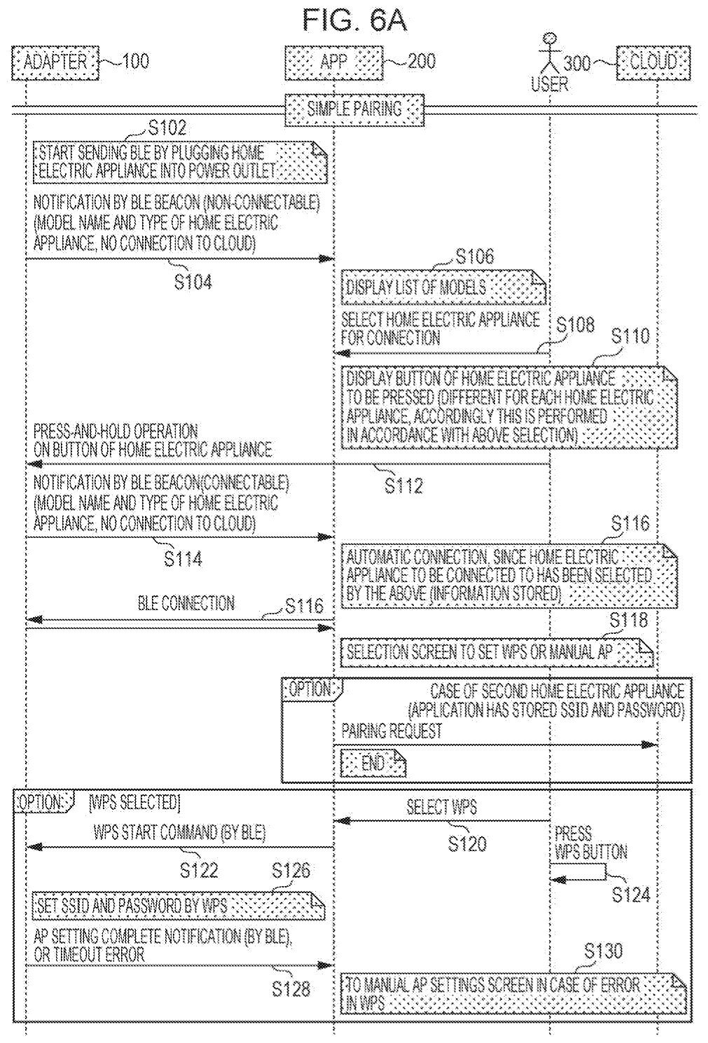

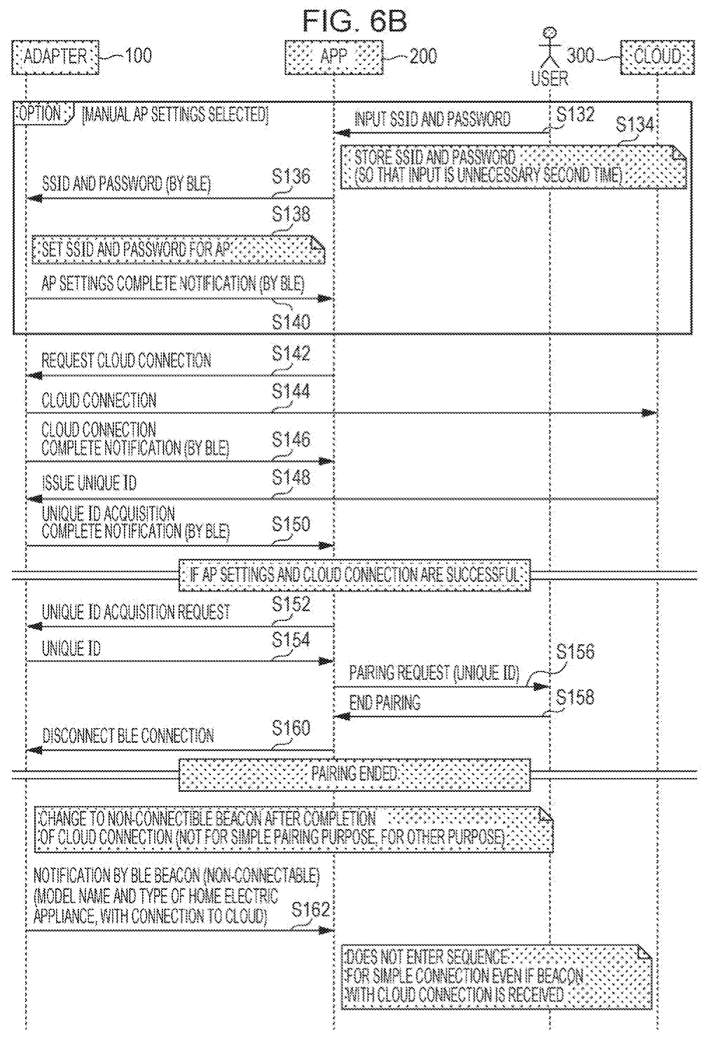

Next, information processing on the network system 1 according to the present embodiment will be described with reference to FIGS. 6A and 6B. First, the electric apparatus 100 is purchased and the power is turned on (step S102). The CPU 110 of the electric apparatus 100 broadcasts a non-connectable beacon by a BLE-compliant communication scheme via the communication interface 160 (step S104). The non-connectable beacon includes the model name of the electric apparatus 100, and identification information for identifying the electric apparatus 100.

The CPU 210 of the communication terminal 200 receives a beacon via the communication interface 260, and selectably displays model names of electric apparatuses 100 on the display 230, in accordance with an application program in the memory 220 (step S106). The user selects the electric apparatus 100 via the operating unit 240 (step S108).

The CPU 210 of the communication terminal 200 downloads an instruction manual indicating procedures for Wi-Fi (registered trademark) connection of the electric apparatus 100 via the Internet, by using the communication interface 260. The CPU 210 of the communication terminal 200 displays the instruction manual on the display 230 (step S110). For example, display is made to the effect that a “press-and-hold” operation is to be performed on a predetermined button of the operating unit 140 of the electric apparatus 100.

Upon the user performing a “press-and-hold” operation on a predetermined button of the operating unit 140 of the electric apparatus 100 (step S112), the CPU 110 of the electric apparatus 100 broadcasts a connectable beacon by a BLE-compliant communication scheme via the communication interface 160 (step S114). The connectable beacon includes the model name of the electric apparatus 100, and identification information for identifying the electric apparatus 100.

Upon confirming, on the basis of the identification information of the electric apparatus 100 selected in step S108 and the identification information included in the connectable beacon, that both are the same, the CPU 210 of the communication terminal 200 may pair with the electric apparatus 100 by a BLE-compliant communication scheme via the communication interface 260 (step S116). At this time, the electric apparatus 100 may also pair with the communication terminal 200 by acquiring from the communication terminal 200 the identification information of the electric apparatus 100 selected in step S108.

That is to say, in the present embodiment, the communication terminal 200 determines that the identification information included in the non-connectable beacon and identification information included in the connectable beacon agree, thereby transitioning to pairing processing without the user performing confirmation operations, i.e., automatically.

The CPU 210 of the communication terminal 200 displays a screen on the display 230 for selecting whether connection by WPS or connection by manual input is to be performed (step S118).

Note that in a case where the electric apparatus 100 this time is the second electric apparatus 100 with regard to the home electric appliance control service for the application of the communication terminal 200, and pairing with the first electric apparatus 100 in the home electric appliance control service has already been completed, the CPU 210 of the communication terminal 200 can request the server 300 for pairing with the electric apparatus 100 via the communication interface 260.

Upon WPS being selected (step S120), the CPU 210 of the communication terminal 200 instructs the electric apparatus 100 to start Wi-Fi (registered trademark) connection by WPS by a BLE-compliant communication scheme via the communication interface 260 (step S122). The CPU 110 of the electric apparatus 100 enables wireless LAN. Upon the user pressing a WPS button of the router 400 (step S124), the CPU 110 of the electric apparatus 100 makes Wi-Fi (registered trademark) connection by setting a service set identifier (SSID) and password (step S126). The CPU 110 of the electric apparatus 100 transmits, via the communication interface 160, a notification, to the communication terminal 200, that Wi-Fi (registered trademark) connection with the router 400 has been completed (step S128). Note that in a case where connection by WPS has failed, the flow transitions to manual Wi-Fi (registered trademark) connection processing (step S130).

On the other hand, when the manual input mode is selected, the CPU 210 of the communication terminal 200 accepts input of SSID and password via the operating unit 240 (step S132). The CPU 210 stores the SSID and password in memory 220 for pairing with a second and subsequent electric apparatuses 100 (step S134).

The CPU 210 transmits the SSID and password to the electric apparatus 100 by a BLE-compliant communication scheme, via the communication interface 260 (step S136). The CPU 110 of the electric apparatus 100 enables wireless LAN. The CPU 110 of the electric apparatus 100 makes Wi-Fi (registered trademark) connection by setting the SSID and password (step S138). The CPU 110 of the electric apparatus 100 transmits to the communication terminal 200, via the communication interface 160, a notification that Wi-Fi (registered trademark) connection with the router 400 has been completed (step S140).

Next, upon having received the notification of Wi-Fi (registered trademark) connection completion of the electric apparatus 100 via the communication interface 260, the CPU 210 of the communication terminal 200 requests the electric apparatus 100 to connect to the server 300 in the cloud, by a BLE-compliant communication scheme via the communication interface 260 (step S142).

The CPU 110 of the electric apparatus 100 connects to the server 300 via the Wi-Fi (registered trademark) router 400 on the basis of the connection request, using the communication interface 160 (step S144). Once connected to the server 300, the CPU 110 performs transmission to the communication terminal 200 to the effect that connection has been completed, by a BLE-compliant communication scheme via the communication interface 160 (step S146).

The CPU 310 of the server 300 issues a connection ID unique to the electric apparatus 100 (step S148). The CPU 110 of the electric apparatus 100 notifies the communication terminal 200 that a connection ID has been acquired, via the communication interface 160 by a BLE-compliant communication scheme (step S150).

The CPU 210 of the communication terminal 200 makes a request for the connection ID, via the communication interface 260 by a BLE-compliant communication scheme (step S152). The CPU 110 of the electric apparatus 100 notifies the communication terminal 200 of the connection ID, via the communication interface 160 by a BLE-compliant communication scheme (step S154).

The CPU 210 of the communication terminal 200 uses the communication interface 260 to request the server 300, via the Internet, for pairing with the electric apparatus 100 with regard to the home electric appliance control service (step S156). At this time, the communication terminal 200 presents the server 300 with the unique connection ID acquired from the electric apparatus 100.

The CPU 310 of the server 300 authenticates that the communication terminal 200 is the partner of the electric apparatus 100 on the basis of this connection ID, and performs pairing of the communication terminal 200 and electric apparatus 100 with regard to the home electric appliance control service (step S158). The server 300 notifies the communication terminal 200 that pairing has ended (step S158). The CPU 210 of the communication terminal 200 disconnects the connection by the BLE-compliant communication scheme with the electric apparatus 100 (step S160).

Thereafter, even if the electric apparatus 100 broadcasts a non-connectable beacon by a BLE-compliant communication scheme (step S162), the communication terminal 200 does not transition to a connection sequence.

### Second Embodiment

In addition to the configuration of the embodiment described above, a period from the start of notification in S104 in FIG. 6A to success in pairing of the communication terminal 200 and electric apparatus 100 in S116 may be set. Note that with regard to the timing of start of this period, the timing at which a non-connectable beacon is first emitted from the electric apparatus 100 may be stored in the electric apparatus 100, the timing at which this beacon is first received by the communication terminal 200 may be stored in the communication terminal 200, the timing at which a notification to the user is output from a user interface with regard to this beacon may be stored in the communication terminal 200, or the timing at which the user responds may be stored in the communication terminal 200.

More specifically, the CPU 110 of the electric apparatus 100 may transmit time elapsed from step S104 or remaining time to the communication terminal 200, or display this time on the display 130 or perform audio output thereof from the speaker 170. The CPU 210 of the communication terminal 200 may then also display time elapsed from step S104 or remaining time on the display 230 or perform audio output thereof from the speaker 270. In a case where pairing does not succeed in this period, the communication terminal 200 or electric apparatus 100 then outputs a message that pairing has failed, prompting the user to manually perform Wi-Fi (registered trademark) connection processing from the beginning.

Furthermore, the duration of this period may be different for each type of electric apparatus 100. For example, the period may be set to be somewhat long for refrigerators and air conditioners which are often installed by professional workers, such as five hours for example, and the period may be set to be somewhat short, such as one hour for example, for washing machines, television sets, and so forth, which users often install themselves.

### Third Embodiment

The emission intervals and emission outputs may be different between non-connectable beacons and connectable beacons in the above-described embodiments. For example, an arrangement may be made where the emission interval of non-connectable beacons by the CPU 110 of the electric apparatus 100 via the communication interface 160 is set to be long to suppress electric power consumption, such as once every three seconds for example, while the emission interval of connectable beacons is set to be short to discover apparatuses for pairing as quickly as possible, once every 100 milliseconds for example, or the like.

Also, in the same way, the CPU 210 of the communication terminal 200 may shorten the BLE scan intervals via the communication interface 260 after step S110 in FIG. 6A, and broaden the scan window.

Also, the CPU 110 of the electric apparatus 100 may set the emission output of non-connectable beacons to be low so as reduce the frequency of discovery thereof by an unrelated entity outside of the home, and set the emission output of connectable beacons to be high so as to raise the probability of connection, via the communication interface 160.

### Fourth Embodiment

Although a BLE-compliant communication scheme has been used in direct exchange of data between the communication terminal 200 and electric apparatuses 100 in the above embodiment, other wireless communication schemes may be used. Also, while Wi-Fi (registered trademark) connection has been used for communication between the electric apparatuses 100 and the server 300, another wireless communication scheme may be used here as well.

### Fifth Embodiment

Part or all of the roles of the devices in the network system 1 according to the above-described embodiments may be executed by another device. For example, another device may assume part or all of the roles of the electric apparatuses 100, communication terminal 200, server 300, or router 400, or multiple devices may assume part or all of the roles.

### Summarization

In the above embodiments, there is provided a network system including an electric apparatus and a communication terminal. The electric apparatus emits a non-connectable beacon by a first communication scheme compliant to Bluetooth (registered trademark). The communication terminal outputs a notification for connection based on the non-connectable beacon. The electric apparatus emits a connectable beacon by the first communication scheme in a case where the electric apparatus directly accepts an operation of a user. In a case where the communication terminal receives the connectable beacon after the user responds to the notification, the communication terminal and the electric apparatus connect to each other by the first communication scheme.

The non-connectable beacon from the electric apparatus may include information for identifying the electric apparatus. The connectable beacon from the electric apparatus may include information for identifying the electric apparatus. In a case where the communication terminal receives the connectable beacon, and the information for identifying the electric apparatus included in the connectable beacon agrees with the information for identifying the electric apparatus included in the non-connectable beacon received earlier, the communication terminal and the electric apparatus may connect to each other by the first communication scheme.

The electric apparatus may emit the non-connectable beacon at a first time interval, and emit the connectable beacon at a second time interval shorter than the first time interval.

The electric apparatus may emit the connectable beacon at an output higher than an output of the non-connectable beacon.

When the communication terminal is connected to the electric apparatus by the first communication scheme, and accepts a predetermined operation, the communication terminal may instruct the electric apparatus to connect to a router by a second communication scheme compliant to Wi-Fi (registered trademark).

The network system may further include a server. When the electric apparatus is connected to the router by the second communication scheme, the server may provide an identification ID to the electric apparatus. The server may perform pairing of the electric apparatus and the communication terminal when the communication terminal acquires the identification ID from the electric apparatus by the first communication scheme and transmits the identification ID to the server.

The network system may further include a server. In a case where the user responds to the notification, the communication terminal may download, from the server, information including procedures for connecting the electric apparatus to the router.

In the network system, the electric apparatus may include a first electric apparatus and a second electric apparatus. A period from the notification based on the non-connectable beacon to the connection based on the connectable beacon may be set to be different between the first electric apparatus and the second electric apparatus.

Information indicating a period from the notification based on the non-connectable beacon to the connection based on the connectable beacon may be displayed at the electric apparatus or the communication terminal.

In the above embodiments, there is provided a communication terminal including a communication interface, a display or a speaker, an operating unit, and a processor. The processor receives a non-connectable beacon from an electric apparatus by a first communication scheme compliant to Bluetooth (registered trademark), via the communication interface, and outputs a notification for connection via the display or the speaker, and in a case of receiving a connectable beacon from the electric apparatus after accepting a user operation via the operating unit, the processor and the electric apparatus connect to each other by the first communication scheme, via the communication interface.

The processor may determine whether identification information of the electric apparatus included in the non-connectable beacon and identification information of the electric apparatus included in the connectable beacon are identical. In a case where the identification information of the electric apparatus included in the non-connectable beacon and the identification information of the electric apparatus included in the connectable beacon are identical, the processor and the electric apparatus may connect to each other by the first communication scheme, via the communication interface.

In the above embodiments, there is provided a non-transitory recording medium storing a program for a communication terminal including a communication interface, a display or a speaker, an operating unit, and a processor. The program causes the processor to execute a process including receiving a non-connectable beacon from an electric apparatus by a first communication scheme compliant to Bluetooth (registered trademark), via the communication interface, outputting a notification for connection via the display or the speaker, and in a case of receiving a connectable beacon from the electric apparatus after accepting a user operation via the operating unit, connecting to the electric apparatus by the first communication scheme, via the communication interface.

It should be understood that the embodiments disclosed herein are exemplary in all points and are not restrictive. The scope of the present disclosure is set forth in the Claims, not the above description, and all modifications within meanings and scopes equivalent to those of the Claims are intended to be encompassed.

The present disclosure contains subject matter related to that disclosed in Japanese Priority Patent Application JP 2019-063361 filed in the Japan Patent Office on Mar. 28, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A network system, comprising:
at least one electric apparatus; and
a communication terminal, wherein
the at least one electric apparatus emits a non-connectable beacon by a first communication scheme compliant to Bluetooth (registered trademark),
the communication terminal outputs a notification for connection based on the non-connectable beacon,
the at least one electric apparatus emits a connectable beacon by the first communication scheme in a case where the at least one electric apparatus directly accepts an operation of a user, and
in a case where the communication terminal receives the connectable beacon after the user responds to the notification, the communication terminal and the at least one electric apparatus connect to each other by the first communication scheme.

2. The network system according to claim 1, wherein
the non-connectable beacon from the at least one electric apparatus includes information for identifying the at least one electric apparatus,
the connectable beacon from the at least one electric apparatus includes information for identifying the at least one electric apparatus, and
in a case where the communication terminal receives the connectable beacon, and the information for identifying the at least one electric apparatus included in the connectable beacon agrees with the information for identifying the at least one electric apparatus included in the non-connectable beacon received earlier, the communication terminal and the at least one electric apparatus connect to each other by the first communication scheme.

3. The network system according to claim 1,
wherein the at least one electric apparatus emits the non-connectable beacon at a first time interval, and emits the connectable beacon at a second time interval shorter than the first time interval.

4. The network system according to claim 1,
wherein the at least one electric apparatus emits the connectable beacon at an output higher than an output of the non-connectable beacon.

5. The network system according to claim 1,
wherein when the communication terminal is connected to the at least one electric apparatus by the first communication scheme, and accepts a predetermined operation, the communication terminal instructs the at least one electric apparatus to connect to a router by a second communication scheme compliant to Wi-Fi (registered trademark).

6. The network system according to claim 5, further comprising
a server, wherein
when the at least one electric apparatus is connected to the router by the second communication scheme, the server provides an identification ID to the at least one electric apparatus, and
the server performs pairing of the at least one electric apparatus and the communication terminal when the communication terminal acquires the identification ID from the at least one electric apparatus by the first communication scheme and transmits the identification ID to the server.

7. The network system according to claim 5, further comprising
a server,
wherein, in a case where the user responds to the notification, the communication terminal downloads, from the server, information including procedures for connecting the at least one electric apparatus to the router.

8. The network system according to claim 1, wherein
the at least one electric apparatus includes a first electric apparatus and a second electric apparatus, and
a period from the notification based on the non-connectable beacon to the connection based on the connectable beacon is set to be different between the first electric apparatus and the second electric apparatus.

9. The network system according to claim 1,
wherein information indicating a period from the notification based on the non-connectable beacon to the connection based on the connectable beacon is displayed at the at least one electric apparatus or the communication terminal.

10. A communication terminal, comprising:
a communication interface;
a display or a speaker;
an operating unit; and
a processor, wherein
the processor
receives a non-connectable beacon from an electric apparatus by a first communication scheme compliant to Bluetooth (registered trademark), via the communication interface, and
outputs a notification for connection via the display or the speaker, and
in a case of receiving a connectable beacon from the electric apparatus after accepting a user operation via the operating unit, the processor and the electric apparatus connect to each other by the first communication scheme, via the communication interface.

11. The communication terminal according to claim 10, wherein
the processor determines whether identification information of the electric apparatus included in the non-connectable beacon and identification information of the electric apparatus included in the connectable beacon are identical, and
in a case where the identification information of the electric apparatus included in the non-connectable beacon and the identification information of the electric apparatus included in the connectable beacon are identical, the processor and the electric apparatus connect to each other by the first communication scheme, via the communication interface.

12. A non-transitory recording medium storing a program for a communication terminal including a communication interface, a display or a speaker, an operating unit, and a processor, the program causing the processor to execute a process comprising:
receiving a non-connectable beacon from an electric apparatus by a first communication scheme compliant to Bluetooth (registered trademark), via the communication interface;
outputting a notification for connection via the display or the speaker; and
in a case of receiving a connectable beacon from the electric apparatus after accepting a user operation via the operating unit, connecting to the electric apparatus by the first communication scheme, via the communication interface.
